(19) United States
(12) Patent Application Publication
(10) Pub. No.: US 2009/0224019 A1
(43) Pub. Date: Sep. 10, 2009

(54) OPTICAL FIBER CUTTING METHOD, DEVICE USED IN SAME METHOD, AND CONNECTOR ASSEMBLY METHOD INCLUDING SAME METHOD

(75) Inventors: Kenichiro Ohtsuka, Kanagawa (JP); Masahiro Hamada, Kanagawa (JP)

Correspondence Address: GLOBAL IP COUNSELORS, LLP, 1233 20TH STREET, NW, SUITE 700, WASHINGTON, DC, 20036-2680, US

(73) Assignee: Sumitomo Electric Industries , Ltd., Osaka-shi ,Osaka (JP)

(21) Appl. No.: 11/994,307

(22) PCT Filed: Apr. 9, 2007
(86) PCT No.: PCT/JP2007/057815

§ 371 Date: Dec. 28, 2007

(30) Foreign Application Priority Data
Apr. 10, 2006 (JP) 2006-108101

(51) Int. Cl. B26F 3/00; C03B 37/16

(52) U.S. Cl. 225/2; 225/96.5; 225/102

(57) ABSTRACT

A method of cutting an optical fiber easily on site such that its end face after being cut slants with respect to its optical axis A twist is applied to at least a portion of the optical fiber. A notch is formed in the coating and the fiber of the optical fiber at the cutting position, and an external force is applied to the optical fiber and cuts the optical fiber at the cutting position. The cutting device includes an optical fiber fixing means that fixes the optical fiber on one side of the cutting position of the optical fiber, optical fiber rotating means that fixes the optical fiber on its other side such that the optical fiber may freely rotate, and a blade that places the notch in the coating and the glass fiber.

### TECHNICAL FIELD

The present invention relates to a method of cutting an optical fiber together with its coating, a device used in the method, and a connector assembly method including the cutting method.

### BACKGROUND ART

A method of cutting an optical fiber together with its coating is disclosed in Japanese Patent Application Publication No. 2005-345530. In this method, a front clamper and a rear clamper of optical fiber supporting means respectively support the front and rear of a cutting position of an optical fiber, and tension applying means urges the front and rear clampers in directions away from each other to apply tension to the clamped optical fiber. Then, a rotating blade cuts a coating and a glass fiber in this state. By cutting the optical fiber under the applied tension, the glass fiber can be cut such that the end face of the glass fiber is perpendicular and flat with respect to the optical axis. Further, because the coating and the glass fiber are cut at the same time, the number of man-hours can be reduced.

Incidentally, when glass fibers having end faces that are perpendicular with respect to their optical axes are interconnected, part of the optical signal is reflected and returns in the incident direction when the optical signal passes through the connecting faces. When two-way communication is performed by a single optical fiber, reflected light resulting from transmitted light in one direction interferes with transmitted light in the opposite direction, and a disadvantage particularly arises. Thus, the reflection direction of the reflected light has been shifted by causing the connecting faces to slant and interconnecting the connecting faces to prevent adverse affects on the transmitted light.

However, causing the connecting faces of the optical fibers to slant has heretofore been performed by working such as polishing. For that reason, when optical fibers are to be delivered to homes, cutting the optical fibers, working the end faces such that they slant with respect to their optical axes, and then interconnecting the optical fibers in the field is not only cumbersome and requiring time but also technically difficult.

### Patent Document 1: Japanese Patent Application Laid-Open Publication No. 2005-345530

### DISCLOSURE OF THE INVENTION

### Problem that the Invention is to Solve

It is an object of the present invention to provide a method of cutting an optical fiber easily in the field such that its end face after being cut slants with respect to its optical axis, a cutting device used in the method, and a connector assembly method including the cutting method.

### Means for Solving the Problem

In order to achieve this object, there is provided a method of cutting an optical fiber having a glass fiber and a coating that covers the glass fiber. In this method, a twist is imparted to a portion of the optical fiber including a cutting position, a notch is formed in the coating and the glass fiber at the cutting position, and an external force is applied to the optical fiber whereby the optical fiber is cut at the cutting position.

The twist may be imparted to the portion of the optical fiber including the cutting position by fixing the optical fiber at one side of the cutting position and rotating the optical fiber at the other side. Further, in a state where one side face of the optical fiber is supported and side pressure is applied thereto at the cutting position, the notch may be formed in the coating and the glass fiber from the other side face.

In another aspect of the invention, there is provided a device that cuts an optical fiber having a glass fiber and a coating that covers the glass fiber. The device includes optical fiber holding means that fixes the optical fiber on one side of a cutting position of the optical fiber, optical fiber rotating means that fixes the optical fiber, such that the optical fiber may freely rotate, on the other side of the cutting position of the optical fiber, and a blade that forms a notch in the coating and the glass fiber. The cutting device may also include connector holding means that releasably holds a connector that will attach to a front end of the optical fiber, and a connector may be held in the connector holding means.

In yet another aspect of the invention, there is provided a connector assembly method comprising the following steps (1) to (6): (1) inserting an optical fiber having a glass fiber and a coating that covers the glass fiber into a connector, and pulling out a front end portion of the optical fiber from a connector; (2) fixing the optical fiber in optical fiber holding means of the connector and fixing the front end portion of the optical fiber in optical fiber rotating means; (3) rotating the optical fiber rotating means to impart a twist to a portion of the optical fiber including a cutting position; (4) forming a notch in the coating and the glass fiber at the cutting position; (5) applying an external force to the optical fiber and cutting the optical fiber at the cutting position; and (6) temporarily releasing the optical fiber holding means, pulling back the optical fiber until its cut face is positioned in a predetermined position inside the connector, and then again fixing the optical fiber in the optical fiber holding means.

### ADVANTAGES OF THE INVENTION

According to the present invention, an optical fiber having a glass fiber and a coating that covers the glass fiber is cut in a state where it is twisted, so the optical fiber can be cut easily in the field such that its end face after being cut slants with respect to its optical axis. Further, the number of man-hours can be reduced because cutting the optical fiber together with its coating makes a step of removing the coating unnecessary.

### BRIEF DESCRIPTION OF THE DRAWINGS

In FIG. 1, region (A) to region (C) are schematic diagrams showing steps in an embodiment of an optical fiber cutting method pertaining to the present invention.

FIG. 2 includes a front diagram and both side end face diagrams showing a state where an optical fiber has been placed in a cutting device in the embodiment of the optical fiber cutting method pertaining to the present invention.

FIG. 3 is a cross-sectional diagram showing the optical fiber being cut by a blade in the embodiment of the optical fiber cutting method pertaining to the present invention.

FIG. 4 is a graph showing the relationship between the rotational angle of optical fiber rotating means and an angle that an end face of the optical fiber after being cut forms with respect to its optical axis in the embodiment of the optical fiber cutting method pertaining to the present invention.

FIG. 5 is a schematic diagram showing an embodiment of an optical fiber cutting device pertaining to the present invention, with region (A) being a plan diagram and region (B) being a cross-sectional diagram at position B-B in region (A).

In FIG. 6, region (A) includes a front diagram and a side diagram showing a first embodiment of the blade and region (B) is a front diagram showing a second embodiment of the blade.

In FIG. 7, region (A) to region (D) are schematic diagrams showing steps in an embodiment of a connector assembly method pertaining to the present invention.

FIG. 8 is a cross-sectional diagram showing an example of connector interconnection using connectors manufactured by the connector assembly method pertaining to the present invention.

### DESCRIPTION OF THE REFERENCE NUMERALS

| | | | |
|---|---|---|---|
| 10 | Cutting Device | 11 | Optical Fiber |
| 11a | Glass Fiber | 11b | Coating |
| 12 | Cutting Position | 13 | Blade |
| 21 | Optical Fiber Holding | 22 | Optical Fiber Rotating |
| | Means | | Means |
| 23 | Side Pressure Member | 24 | Connector Holding Means |
| 30 | Connector | | |

### BEST MODES FOR CARRYING OUT THE INVENTION

Embodiments of the present invention will be described below with reference to the drawings. The drawings are for explanatory purposes and are not be intended to limit the scope of the invention. In the drawings, the same reference numerals represent the same parts in order to avoid redundancy of description. The proportions of dimensions in the drawings are not necessarily accurate.

To begin, an embodiment of an optical fiber cutting method pertaining to the present invention will be described. In FIG. 1, region (A) to region (C) are schematic diagrams showing steps in the embodiment of the cutting method. First, a relative twist is imparted to both sides of an optical fiber 11 on either side of a cutting position 12 (region (A)). Next, a notch 12a is formed in a coating lib and a glass fiber 11a in this twisted state (region (B)). Then, an external force F is applied to the optical fiber 11 and the optical fiber 11 is cut at the cutting position 12 (region (C)). Though, in region (C), an external force F that is perpendicular to the axis of the optical fiber 12 is applied and the optical fiber is cut, an external force that pulls the optical fiber 12 towards both sides may also be applied to cut the optical fiber.

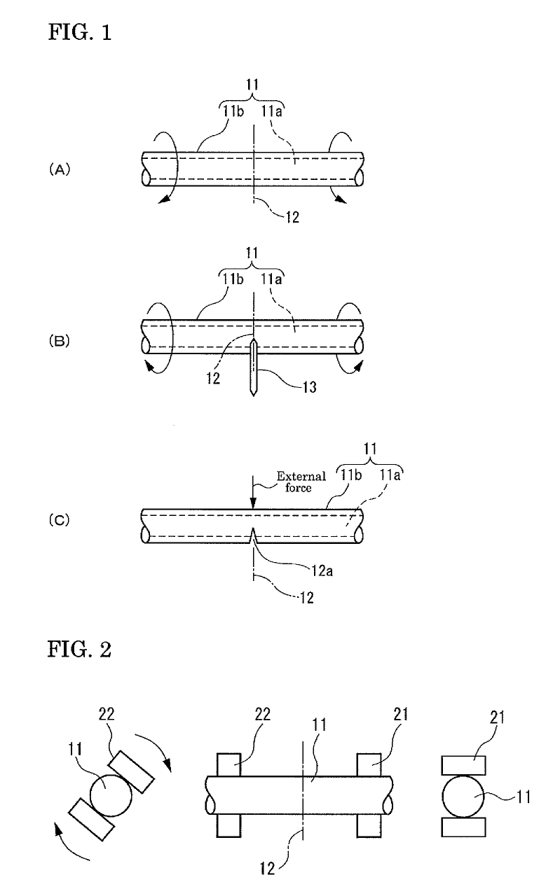

FIG. 2 includes a front diagram and both side end face diagrams showing a state where the optical fiber has been placed in a cutting device. One side (right side) of the optical fiber 11 with respect to the cutting position 12 is fixed by optical fiber holding means 21 and the other side (left side) is rotated by optical fiber rotating means 22, whereby the optical fiber 11 can be twisted at the cutting position. At this time, the twist amount of the optical fiber can be adjusted by the rotational amount of the rotating means 22 and the slant angle of the cut face can be easily adjusted.

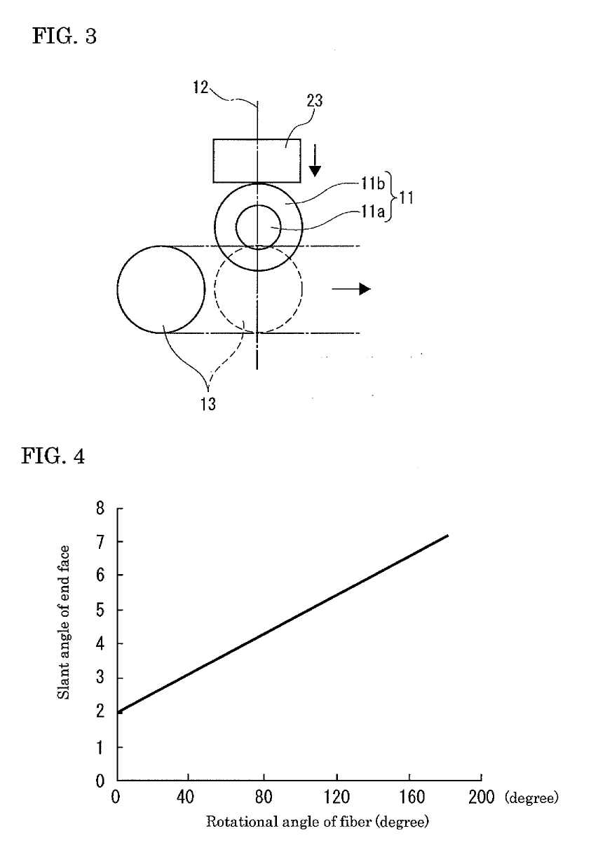

FIG. 3 is a cross-sectional diagram showing the optical fiber being cut by a blade. When the blade cuts into the coating 11b and nicks the glass fiber 11a, it is preferable to apply a force with a side pressure member 23 to one side face (upper face) of the optical fiber 11 at the cutting position 12 and to notch the other side face (lower face) with a blade 13. Thus, the optical fiber 11 can be prevented from escaping when the blade cuts into the optical fiber, and the notch or the like can be reliably formed.

FIG. 4 is a graph showing the relationship between the rotational angle of the optical fiber rotating means and an angle that the end face of the optical fiber after being cut forms with respect to its optical axis, wherein the horizontal axis represents the rotational angle and the vertical axis represents the angle that the end face forms with respect to its optical axis. It is noted that an optical fiber where the outer diameter of the glass fiber 11a is 80 μm and where the outer diameter of the optical fiber 11 is 125 μm is used as the optical fiber 11. By setting the rotational angle of the optical fiber 11 to 100° to 200°, for example, an optical fiber including an end face that slants 5° to 8° with respect to its optical axis is obtained.

According to the embodiment of the optical fiber cutting method of the present invention, the optical fiber 11 is twisted on both sides of the cutting position 12 and cut, so the optical fiber can be cut easily in the field such that its end face after being cut slants with respect to its optical axis. Further, a step of removing the coating 11b becomes unnecessary because the optical fiber 11 is cut together with its coating 11b, and the optical fiber can be efficiently cut in a short amount of time even in the field. It is noted that in the case of cables and cords where the optical fiber 11 is covered by a sheath, the aforementioned cutting is performed after getting rid of the sheath and removing the optical fiber 11 covered with the coating 11b.

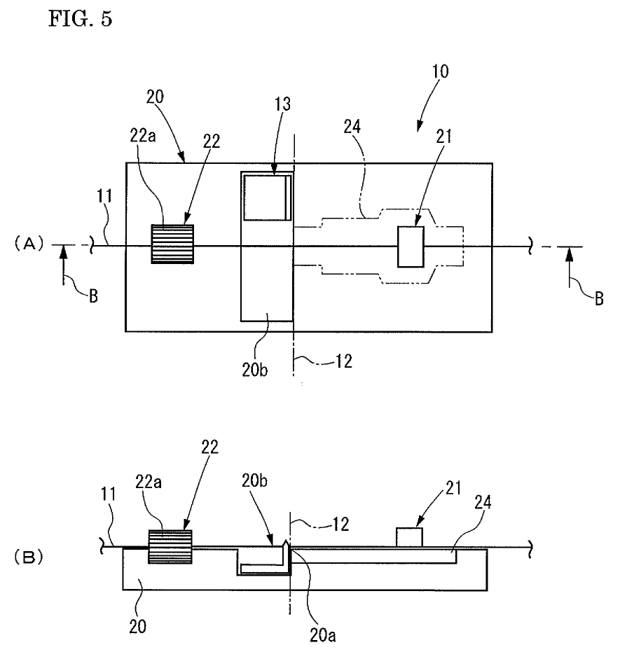

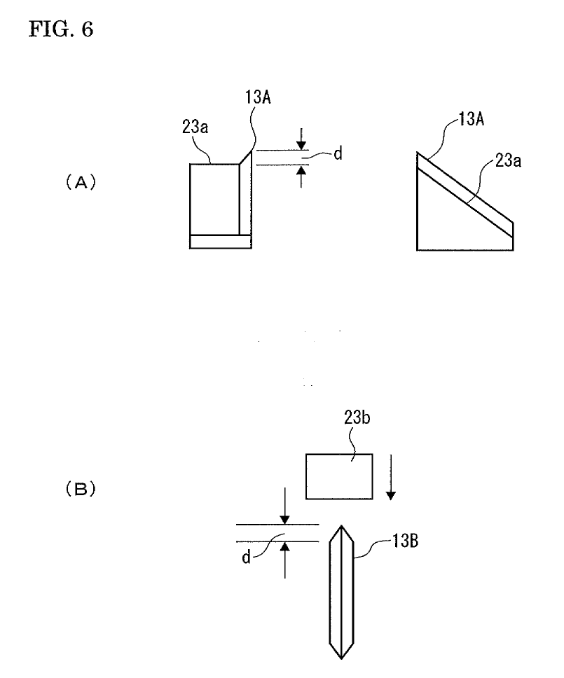

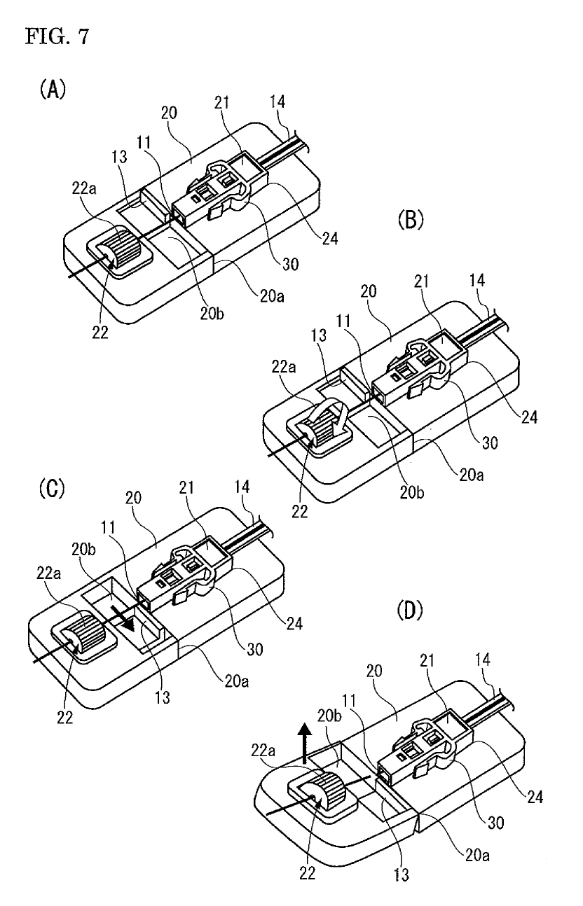

Next, an embodiment of an optical fiber connecting device pertaining to the present invention will be described. FIG. 5 is a schematic diagram showing the embodiment of the optical fiber cutting device pertaining to the present invention, with region (A) being a plan diagram and region (B) being a cross-sectional diagram at position B-B in region (A). An optical fiber cutting device 10 cuts the optical fiber 11 having the glass fiber 11a and the coating 11b that covers the glass fiber 11a. The cutting device 10 includes, on a base 20, the optical fiber holding means 21 on one side of the cutting position 12 (right side in FIG. 5) and the optical fiber rotating means 22 on the other side (left side in FIG. 5). Additionally, the cutting device 10 includes the blade 13 and notch amount adjusting means.

The holding means 21 is disposed such that it may freely open and close upward and downward, for example, and when the holding means 21 closes, it can fix the optical fiber 11 placed along the upper face of the base 20. The rotating means 22 is a circular cylinder-shaped member 22a that may freely rotate and can halt in an arbitrary rotational position, for example, and the optical fiber 11 is capable of being passed through the center of the circular cylinder-shaped member 22a and fixed to the circular cylinder-shaped member 22a. One end of the optical fiber 11 is fixed by the holding means 21 and the other end is rotated by the circular cylinder-shaped member 22a of the rotating means 22, whereby the optical fiber 11 can be twisted at an arbitrary twist angle.

It is preferable to dispose a hinge portion 20a in the base 20 in the vicinity of the cutting position 12 to enable the base 20 to be folded. Thus, by folding the base 20, an external force can be caused to act on the notch 12a in the optical fiber 11.

The blade 13 is slid by driving means such as a spring in a direction substantially perpendicular to the longitudinal direction of the optical fiber 11 and along a recessed portion 20b disposed in a portion of the base 20 corresponding to the cutting position 12, and the blade 13 forms a notch in the coating 11b and the glass fiber 11a. The notch amount adjusting means adjusts the notch amount resulting from the blade 13.

Region (A) of FIG. 6 includes a front diagram and a side diagram showing a first embodiment of the blade. The blade 13 of the first embodiment includes a blade 13A and a support face 23a. The blade 13A is slanted, with its front end (lower side in region (A) of FIG. 5) being low and its rear end having a height that reaches the lower portion of the glass fiber 11a of the optical fiber 11. The slanted support face 23a as the notch amount adjusting means is integrally disposed adjacent to the blade 13A, and the blade 13A protrudes a notch amount d from the support face 23a. When the blade 13A is slid to form the notch 12a in the optical fiber 11, the support face 23a makes contact with the bottom surface of the optical fiber 11, so a notch having a depth corresponding to the protruding amount d is formed in the optical fiber 11.

Region (B) of FIG. 6 is a front diagram showing a second embodiment of the blade. The blade 13 of the second embodiment includes a circular rotating blade 13B, and the blade 13B is slid while being rotated to form a notch in the optical fiber 11. In the second embodiment, the notch amount adjusting means is a side pressure member 23b that is disposed on the optical fiber 11 and applies side pressure from above to the optical fiber 11. The position of the side pressure member 23b is adjusted such that the upper end of the blade 13B slides in a state where it reaches the lower portion of the glass fiber 11a. The side pressure member 23b restricts upward movement of the optical fiber 11 and the rotating blade 13B is caused to slide, so that a notch of the predetermined amount d can be formed in the optical fiber 11.

Further, as shown in region (A) and region (B) of FIG. 5, connector holding means 24 is disposed in the upper face of the base 20. The connector holding means 24 is a groove that is formed on the base 20 and holds a connector, and part of a connector 30 that attaches to the front end of the optical fiber 11 fits into the groove so that the connector holding means 24 can releasably hold the connector 30.

When cutting of the optical fiber 11 is performed using the optical fiber cutting device 10, one side of the cutting position in the longitudinal direction of the optical fiber 11 is fixed to the base 20 by the holding means 21, and the other side is fixed to the rotating means 22. At this time, it is preferable to apply predetermined tension to the optical fiber 11. Then, the rotating means 22 is rotated to twist the optical fiber 11a predetermined angle, the notch 12a is formed in the coating 11b and the glass fiber 11a by the blade 13a, and an external force is applied to the position of the notch 12 to cause the optical fiber 11 to break.

According to the cutting device 10, the optical fiber 11 can be twisted at the cutting position 12, and the notch can be formed by the blade 13 in the coating 11b and the glass fiber 11a of the optical fiber 11 in the twisted state. At this time, the notch amount is adjusted by the notch amount adjusting means, so that a notch can be reliably formed with the predetermined notch amount. Further, by cutting the optical fiber 11 in a state where the connector 30 is attached to the connector holding means 24 and the optical fiber 11 has been passed through the connector 30, the optical fiber 11 can be connected to the connector 30 easily and rapidly.

Next, an embodiment of a connector assembly method pertaining to the present invention will be described. In FIG. 7, region (A) to region (D) are schematic diagrams showing steps in the embodiment of the connector assembly method pertaining to the present invention. In the present embodiment, a connector 30 is held in the connector holding means 24 of the optical fiber cutting device 10 in order to attach the connector 30 to an optical cable 14.

First, the sheath of the optical cable 14 is removed at the front end portion, and the optical fiber 11 covered with the coating 11b is taken out. Then, the optical fiber 11 is passed through the optical fiber holding means 21 and the optical fiber rotating means 22, the optical fiber is fixed to the base 20 by the holding means 21, and the optical fiber is fixed to the rotating means 22 (region (A)). Next, the circular cylinder-shaped member 22a of the rotating means 22 is rotated at a predetermined angle to twist the optical fiber 11 at the cutting position 12 (region (B)). The blade 13 is driven in a state where the optical fiber 11 has been twisted, the coating 11b of the optical fiber 11 is cut by the blade 13, and the notch 12a is formed in part of the glass fiber 11a (region (C)). At this time, a notch of a constant amount is obtained by adjusting the height of the blade 13. Then, the base 20 is folded about the hinge 20a to apply an external force (here, folding force) to the optical fiber 11 and cause the optical fiber 11 to break (region (D)). Thereafter, the optical fiber 11 is pulled back such that the cut face of the optical fiber 11 is positioned in a predetermined position in the connector 30, and the optical cable 14 is fixed to the connector 30.

According to the embodiment of the connector assembly method of the present invention, the optical fiber 11 covered with the coating 11b is fixed to the connector 30, so that time and effort to remove the coating 11b becomes unnecessary and the glass fiber 11a can be prevented from sustaining damage during in the field work. Further, the optical fiber 11 that has been cut such that its front end face slants with respect to its optical axis is fixed to the connector, so that when the optical fibers 11 are to be interconnected via the connector 30, reflected light at the connecting faces can be prevented from returning and adversely affecting communication and the like. It is noted that in the case of cables and cords where the optical fiber is covered with a sheath, a predetermined length of the sheath is removed to take out the covered optical fiber, and the connector is attached. At that time, the optical fiber can be fixed together with the sheath.

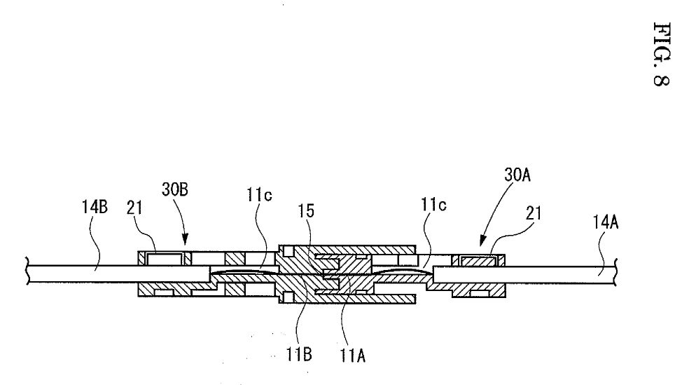

FIG. 8 is a cross-sectional diagram showing an example of connector interconnection using connectors manufactured by the connector assembly method pertaining to the present invention. The connector interconnection shown in FIG. 8 is achieved by interconnecting a connector 30A attached to a first optical cable 14A and a connector 30B attached to a second optical cable 14B, so that the optical cables 14A and 14B become interconnected. The connectors 30A and 30B are male and female connectors assembled by the connector assembly method of the present invention.

Connecting end faces of optical fibers 11A and 11B pulled out from the optical cables 14A and 14B contact each other at a contact face 15. Before the connectors 30A and 30B are interconnected, the optical fiber 11A protrudes a predetermined amount from the front end of the connector 30A and the optical fiber 11B protrudes a predetermined amount from the front end of the connector 30B. When the connectors 30A and 30B from which the optical fibers 11A and 11B protrude are interconnected as shown in FIG. 8, slanted end faces D of the optical fibers 11A and 11B contact and collide with each other so that the optical fibers 11A and 11B are caused to move toward the rear sides of the connectors 30A and 30B. The optical fibers 11A and 11B that have been caused to move bend in bend-accommodating spaces 11c inside the connectors 30A and 30B.

At this time, the connecting end faces of the optical fibers 11A and 11B push against each other and are reliably interconnected because of a force resulting from the bent optical fibers 11A and 11B trying to extend. Both of the connecting end faces slant a predetermined angle with respect to a plane orthogonal to the optical axis and surface-contact each other in a slanted state, so reflected light at the connecting faces becomes reflected in a direction different from the optical axis direction, and connection characteristics can be improved.

It is noted that the optical fiber cutting method and the optical fiber cutting device of the present invention are not limited to the aforementioned embodiments and may be appropriately altered and improved.

This application is based on a Japanese patent application (Japanese Patent Application No. 2006-108101) filed on Apr. 10, 2006, and the disclosure thereof are incorporated by reference herein.

### INDUSTRIAL APPLICABILITY

The optical fiber cutting method, the device used in the same method, and the connector assembly method including the same method are effective as a method of cutting an optical fiber in the field and diagonally working its end face.

1. A method of cutting an optical fiber comprising a glass fiber and a sheath that covers the glass fiber, the method comprising:
imparting a twisting to a portion of an optical fiber including a cutting position;
forming a notch in the coating and the glass fiber at the cutting position; and
applying an external force to the optical fiber to cut the optical fiber at the cutting position.

2. The optical fiber cutting method of claim 1, wherein
the twisting step includes fixing one portion of the optical fiber on a first side of the cutting position and rotating the optical fiber on a second side of the cutting position.

3. The optical fiber cutting method of claim 1, wherein
the notch forming step includes supporting a first longitudinal side of the optical fiber and applying pressure to the first longitudinal side of the optic fiber at the cutting position, and
in the notch forming step is formed in the coating and the glass fiber from an opposite longitudinal side.

4. A device that cuts an optical fiber having a glass fiber and a coating that covers the glass fiber, the device comprising:
an optical fiber holding means that fixes an optical fiber on a first side of a cutting position of the optical fiber;
an optical fiber rotating means configured to fix and apply torsion to a second side of the cutting position of, the optical fiber; and
a blade configured to that form a notch in the coating and the glass fiber.

5. The cutting device of claim 4, further comprising
a connector holding means that releasably holds a connector that attaches to a portion of the optical fiber adjacent to the cutting position.

6. The cutting device of claim 5, wherein
the connector holding means includes a recess shaped to retain a correspondingly shaped connector.

7. A connector assembly method comprising:
inserting an optical fiber having a glass fiber and a coating that covers the glass fiber into a connector such that a portion of the optical fiber extends out from the connector;
fixing the optical fiber in optical fiber holding means of the connector and fixing the portion of the optical fiber extending out of the connector into an optical fiber rotating means;
rotating the optical fiber rotating means to impart a twist to the portion of the optical fiber including a cutting position;
forming a notch in the coating and the glass fiber at the cutting position;
applying an external force to the optical fiber and cutting the optical fiber at the cutting position; and
temporarily releasing the optical fiber holding means, pulling back the optical fiber until its cut face is positioned in a predetermined position inside the connector, and then again fixing the optical fiber in the optical fiber holding means of the connector.
